(19) United States
(12) Patent Application Publication
(10) Pub. No.: US 2012/0167830 A1
(43) Pub. Date: Jul. 5, 2012

(54) Pet Housing

(76) Inventors: Melaney Northrop, Mansfield, TX (US); Adam W. Weber, Keller, TX (US)

(21) Appl. No.: 13/341,103

(22) Filed: Dec. 30, 2011

Related U.S. Application Data
(60) Provisional application No. 61/429,005, filed on Dec. 31, 2010.

(51) Int. Cl. A01K 1/03

(52) U.S. Cl. 119/496

(57) ABSTRACT

A selectively separable pet housing allows for at least two separable portions to be coupled together to form a cavity between them. In particular, a top portion and a bottom portion may each be selectively coupled to a middle portion or to each other. The top and bottom portions are each configured to have a concave shape whereby, when coupled together, they have a cavity situated between them in which the middle portion may be stored. When the top and bottom portion are each coupled to the middle portion, a pet housing is created in which a pet may be housed.

### CROSS-REFERENCE TO RELATED APPLICATION

The instant application claims priority from U.S. Provisional Patent Application Ser. No. 61/429,005 filed Dec. 31, 2010, the disclosures of which are incorporated herein by reference.

### BACKGROUND

1. Technical Field

The present application relates to pet housings, such as, for example, a pet kennel and, more particularly, to a pet housing having portions interconnected by a zipper and which are nestable for compact storage, shipping, and point of sale display.

2. Related Art

A variety of pet kennels having connectable upper and lower portions have been designed in order to allow for compact storage of these components. These kennel designs typically require a user to connect the upper and lower portions either with a latch or with fastener such as nuts and bolts. Such fasteners typically require the use of tools to complete the assembly, and such fasteners may be easily lost.

Pet kennels are also designed to have upper and lower portions to allow for compact storage, shipping, and display at a point of sale. The size or height of the nested configuration of the upper and lower portions is generally equal to about one half of the height of the assembled kennel. Therefore, the height of the portions of the kennel in their nested configuration typically cannot be made less than approximately one half the total height of the kennel. Also, in the nested configuration, the entryway door of the kennel must be detached and removed from the kennel. The doors are subject to being misplaced or lost, and there are assembly requirements to reconnect the door to the kennel when in the assembled position.

Therefore, a need exists for a pet kennel which is easy to assemble and/or that has improved nestability of its component parts.

### SUMMARY

In accordance with embodiments of the present disclosure, a pet housing includes a top portion having a continuous edge. A bottom portion is provided and has a continuous edge. A middle portion is disposed between the top and bottom portions. The middle portion includes a continuous top edge and a continuous bottom edge. A first zipper is operable between an open position and a closed position to selectively interconnect the top portion continuous edge and the middle portion continuous top edge. A second zipper is operable between an open position and a closed position to selectively interconnect the bottom portion continuous edge and the middle portion continuous bottom edge. When the zippers are in the closed position, the top, bottom and middle portions have an enclosed area disposed therebetween. When the zippers are in the open position, the top and bottom portions are completely detached from the middle portion to allow the portions to nest.

In some embodiments, a selectively separable pet housing is provided that allows for at least two separable portions to be coupled together to form a cavity between them. In particular, a top portion and a bottom portion may each be selectively coupled to a middle portion or to each other. The top and bottom portions are each configured to have a concave shape whereby, when coupled together, they have a cavity situated between them in which the middle portion may be stored. When the top and bottom portion are each coupled to the middle portion, a pet housing is created in which a pet may be housed.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and Detailed Description are to be regarded as illustrative in nature and not restrictive.

### BRIEF DESCRIPTION OF THE DRAWINGS

For a more complete understanding of the present disclosure and for further advantages thereof, reference is now made to the following description of the embodiments taken conjunction with the accompanying drawing in which:

FIG. 1 is a perspective view of the present pet housing in an assembled position;

FIG. 2 is a right side elevational view thereof;

FIG. 3 is a front elevational view thereof;

FIG. 4 is a top plan view thereof;

FIG. 5 is a rear elevational view thereof;

FIG. 6 is an exploded perspective view of the pet housing of FIG. 1;

FIG. 7 is a front elevational view of the entire middle portion of the pet housing of FIG. 1;

FIG. 8 is a perspective view of the disconnected top, bottom, and middle portions of the pet housing exploded from the nested position;

FIG. 9 illustrates a pet housing in accordance with an alternative embodiment;

FIG. 10 is an exploded view of the pet housing of FIG. 9;

FIG. 11 shows a middle portion of the pet housing of FIG. 9 folded;

FIG. 12 shows the folded middle portion of FIG. 11 positioned on a bottom portion of the pet housing of FIG. 9; and

FIG. 13 illustrates a top portion and the bottom portion of the pet housing of FIG. 9 coupled together.

Similar numerals refer to similar parts throughout the specification.

### DETAILED DESCRIPTION

Pet housing embodiments are disclosed which provide selective disassembly for storage, transport, and/or display. In some embodiments, a pet housing is provided that includes three separable parts that may be coupled, i.e., connected together. In some embodiments two sets of zippers may be implemented to couple the parts together. In some embodiments, two of the separable parts may be coupled together to create a cavity therebetween in which a third part may be stored. In other embodiments, parts of the housing may be nested together when separated.

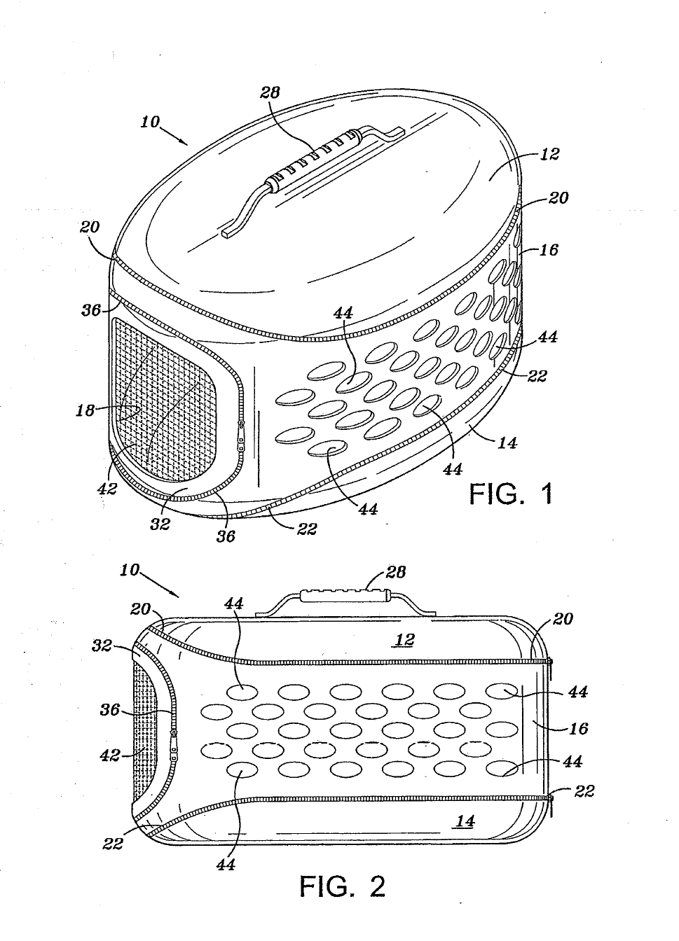

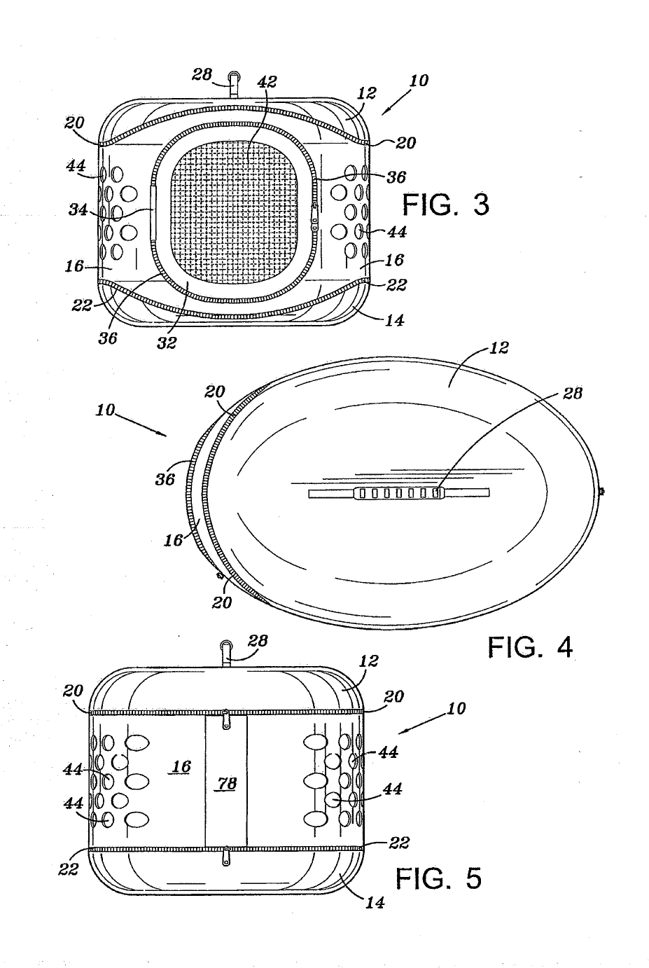

Referring simultaneously to FIGS. 1-5, the present pet housing apparatus is illustrated, and is generally identified by the numeral 10. As used herein, the term “pet housing” or “housing” includes, for example, but is not limited to, a pet kennel, pet shelter, or pet carrier. Housing 10 includes a top portion 12, a bottom portion 14, and a middle portion 16. When assembled, top, bottom, and middle portions 12, 14, and 16 form a pet housing having an enclosed area 18 formed therein for containing a pet. That is, the enclosed area 18 is situated between the top, bottom, and middle portions 12, 14, and 16. Middle portion 16 is interposed between top and bottom portions 12 and 14 in such a configuration of the pet housing 10. Top portion 12 and bottom portion 14 are of essentially the same size and shape to facilitate nesting thereof.

Top portion 12 can be selectively interconnected to middle portion 16 using a first zipper 20. Bottom portion 14 of housing 10 can be selectively interconnected to middle portion 16 with a second zipper 22. First and second zippers 20 and 22 extend around the entirety middle portion 16 and allow top, bottom, and middle portions 12, 14, and 16 to be connected together, and to also be completely detached from one another for purposes of nesting for storage, shipping, and display of housing 10 at a point of sale.

Middle portion 16 of housing 10 includes an entrance way 30 that provides access to enclosed area 18. Entrance way 30 is selectively closable utilizing a door flap 32 which is hingedly attached to middle portion 16 utilizing a hinge 34. Door flap 32 is selectively secured to middle portion 16 of housing 10 in a closed position utilizing a zipper 36. Zipper 36 includes two sets of teeth 38 and 40. Door flap 32 includes a ventilation mesh 42. Door flap 32 is contained within middle portion 16 and is secured to middle portion 16 to ensure that door flap 32 is not misplaced or lost when housing 10 is disassembled.

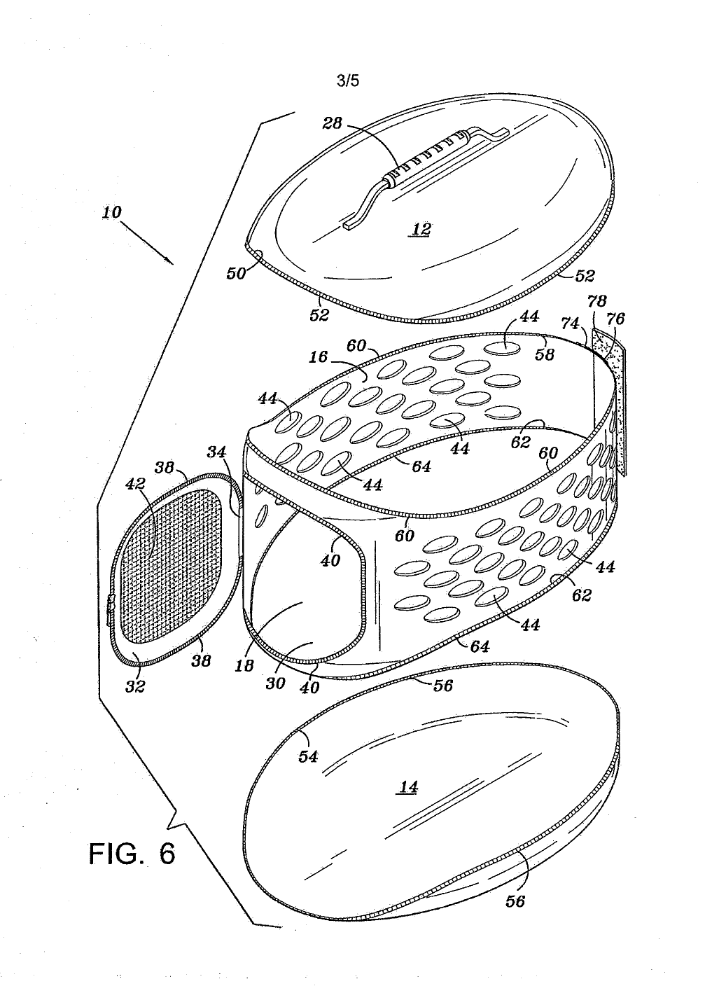

Referring simultaneously to FIGS. 1 and 6, top portion 12 includes a continuous edge 50 to which is attached a row of zipper teeth 52. Bottom portion 14 includes a continuous edge 54 to which is attached a row of zipper teeth 56. Middle portion 16 of housing 10 includes a top continuous edge 58 to which is attached a row of zipper teeth 60. Middle portion 16 further includes a bottom continuous edge 62 to which is attached a row of zipper teeth 64. Zipper teeth 52 and 60 form zipper 20. Zipper teeth 56 and 64 form zipper 22. It is noted, however, that zippers 20 and 22 are merely an example of one type of cooperable fastener apparatus. That is, and by way of example, zipper teeth 52 are cooperable with zipper teeth 60 to form zipper 20. Other types of cooperable fastener apparatuses may alternatively be employed, such as hook and loop fasteners, snaps, buttons, and the like without limitation.

Zipper teeth 52 extend completely around the edge 50 of top portion 12. Similarly, zipper teeth 56 extend completely around edge 54 of bottom portion 14. Zipper teeth 60 and 64 extend continuously around edges 58 and 62, respectively, of middle portion 16. Therefore, it can be seen that top portion 12 and bottom portion 14 are completely detached from middle portion 16 of housing 10 when zippers 20 and 22 are in an open position. Top, bottom, and middle portions 12, 14, and 16 are connected to one another when zippers 20 and 22 are in a closed position.

FIG. 6 illustrates door flap 32 in an open position such that zipper 36 is open to thereby provide access to the enclosed area 18 of housing 10.

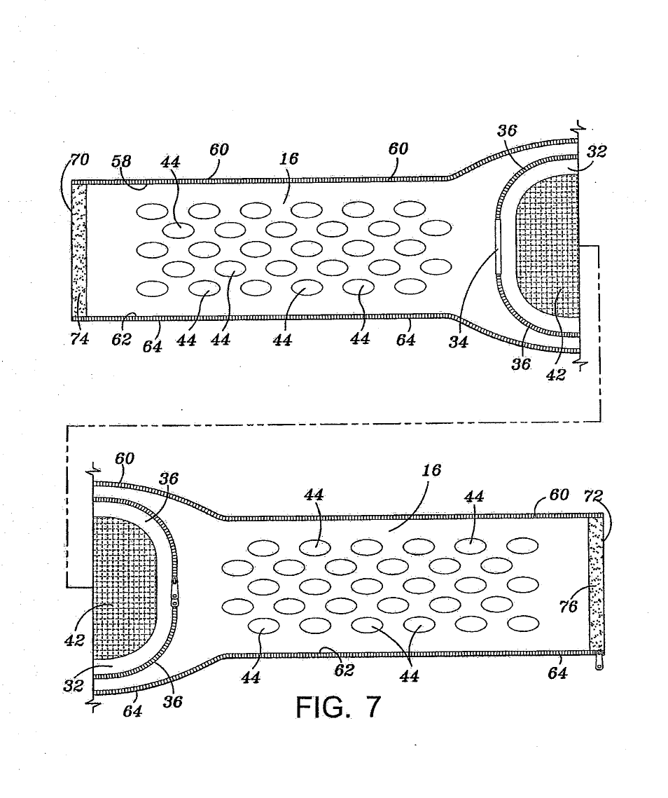

FIG. 7 illustrates middle portion 16 detached from top portion 12 and bottom portion 14 of housing 10. Door flap 32 is in a closed position with zipper 36 in the closed position. Middle portion 16 includes ends 70 and 72 to which are attached components of a fastener such as, for example and without limitation, hook and loop fasteners. For example, a pair of loop strips 74 and 76 can be mounted to middle portion 16 adjacent the ends 70 and 72, and the ends 70 and 72 can be connected together by attaching the loop strips 74 and 76 to a hook strip 78 (FIG. 5). Other fastening methodologies can be employed.

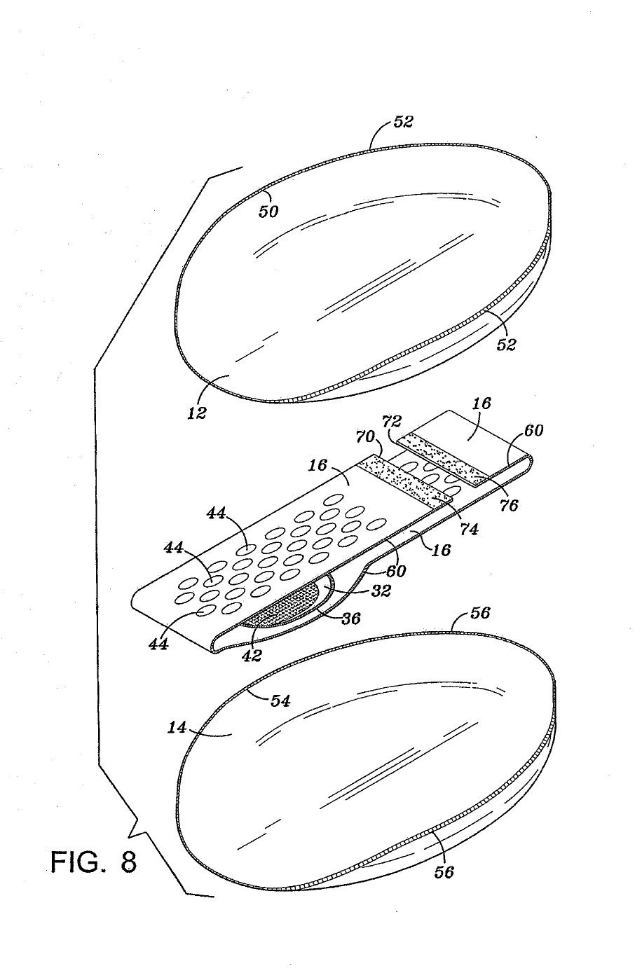

FIG. 8 illustrates housing 10 exploded from a nested position of top portion 12, bottom portion 14 and middle portion 16. Top portion 12 is turned upside down to received at least partially in and to mate with bottom portion 14. Middle portion 16 is folded and inserted between top portion 12 and bottom portion 14 to provide for a compact configuration for storage, shipping and display of housing 10 at a point of sale. Since top portion 12 and bottom portion 14 are essentially the same size, portions 12 and 14 nest together with minimal separation between these components. Middle portion 16 is easily foldable and inserted between nested top portion 12 and bottom portion. 14.

Top, bottom, and middle portions 12, 14, and 16 may be formed from any of a variety of materials, including sheet material such as, for example, ethylene-vinyl acetate (EVA), EVA foam, foamed polyethylene, PVC, nitrile rubber, nylon, etc. Top, bottom, and middle portions 12, 14 and 16 may include different colored and patterned materials to create a variety of aesthetically pleasing looks and assortments for housing 10. Middle portion 16 together with bottom portion 14 can be used without top portion 12 as a pet exercise pen.

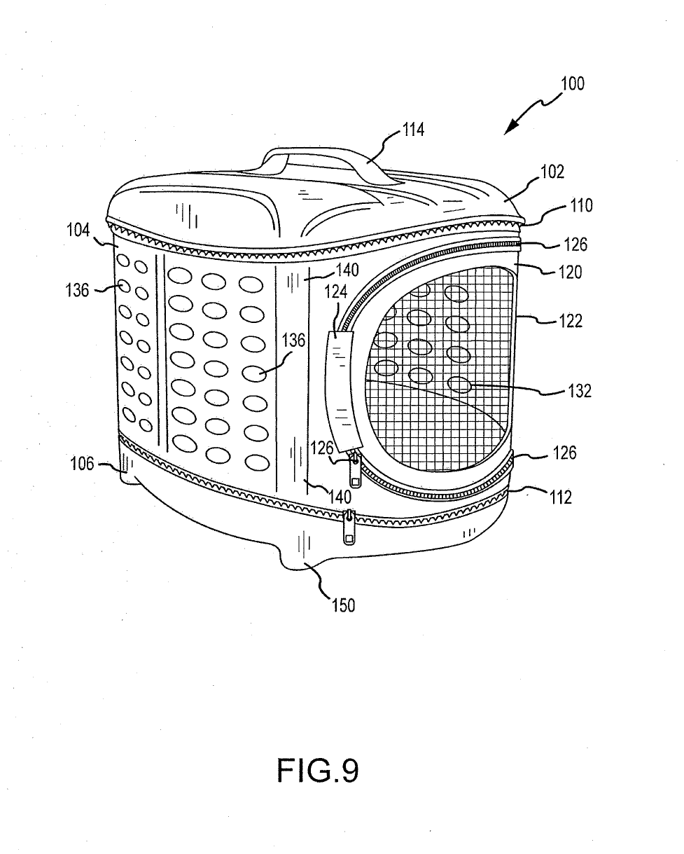

Turning to FIG. 9, another pet housing 100 is illustrated in accordance with an alternative embodiment. The pet housing 100 includes a top portion 102, a middle portion 104 and a bottom portion 106. In some aspects the pet housing 100 is similar to the pet housing 10 described above and shown in FIGS. 1-8. For example, when assembled, top, middle, and bottom portions 102, 104, and 106 form an enclosed area that may be used to house a pet. Top portion 102 and bottom portion 106 may generally have the same size and shape to accommodate nesting.

Top portion 102 may be selectively interconnected with middle portion 104 using a suitable coupling mechanism such as a zipper 110. Bottom portion 106 of housing 100 similarly may be selectively coupled to the middle portion 104 with a suitable coupling mechanism, such as a zipper 112. Other embodiments may implement ties, hook and loop fasteners, snaps, buttons, or other coupling mechanism. In some embodiments, the zippers 110 and 112 may extend around the entire housing 100, and allow the top, middle, and bottom portions 102, 104, and 106 to be completely detached from one another for purposes such as storage, shipping, and display of housing 100 at a point of sale.

Top portion 102 of housing 100 may include a handle 114. In some embodiments, the handle 114 may be positioned at or near the center of the top portion 102. In other embodiments, handles may be provided on the sides of the top portion to allow for two-handed carrying. Moreover, in other embodiments, a handle (not expressly depicted herein) may be provided on the middle portion 104 and/or the bottom portion 106. In other embodiments, handles may have straps that extend underneath the bottom portion 106 to provide support when transporting a pet within the housing 100. When used, such straps may be extendable on two or more sides of the housing 100 and gripped by a user near or above the top portion 102.

Middle portion 104 of housing 100 may include a door 120 providing access to an enclosed area that is situated between the top, middle, and bottom portions 102, 104, and 106. The door 120 may be selectively opened or closed utilizing a door flap 122 which may be hingedly attached to the middle portion 104. A hinge or axis of rotation for the door flap 122 may be obscured, covered and/or reinforced with a material. In some embodiments, a hinge may take the form of a portion of the door flap 122 being sewn to the middle portion 104 of the housing 100. In other embodiments, the hinge may take the form of a portion of a zipper 126 which may be used to selectively secure the door flap 122 to the middle portion 104 of housing 100 in a closed position utilizing a zipper 126. Additionally, the door flap 122 may include a ventilation mesh 132. In some embodiments, the door flap 122 may be contained within middle portion 104 and may be secured to the middle portion 104 to ensure that door flap is not misplaced or lost when housing 100 is disassembled. In other embodiments, the door flap 122 may be removed from the middle portion 104. Moreover, in some embodiments, the door flap 122 may protrude slightly outward from the surface of the middle portion 104.

The middle portion 104 may be a unitary member. That is, the middle portion 104 may be continuous and may take a shape suited to coupling together with the top and bottom portions 102 and 106. When decoupled from the top and bottom portions 102 and 106, the middle portion 104 may generally have a cylindrical, tubular, or open-ended box shape. For example, the middle portion 104 may be made up of one or more panels that are coupled together to form the unitary member. In one embodiment, the middle portion may include four panels that are coupled together to form the unitary member. Specifically, the middle portion 104 may include a front panel that includes the door 120, two side panels that may be substantially similarly dimensioned, and a back panel. Additionally, joints between panels (e.g., at the places where separate panels are joined together) may be reinforced and/or obscured by material 140. The material may help to protect the joints from manipulation by a pet situated in the housing 100 and may provide a more aesthetically pleasing appearance. In some embodiments, one or more panels of the middle portion 104 may include a plurality of ventilation openings 136.

The top and bottom portions 102 and 106 may have shapes that provide certain benefits. For example, the top portion 102 may have a shape that is generally convex (from the perspective of the outside of the pet housing 100) to resist pooling of liquid, such as rain. Additionally, the convex shape provides additional space within the housing 100 for a pet.

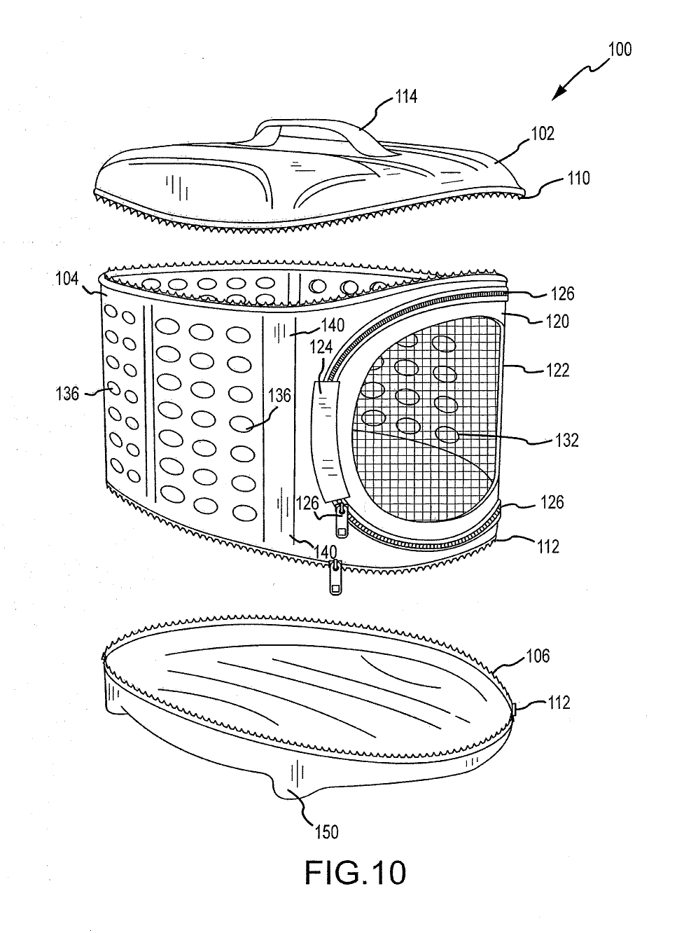

The bottom portion 106 may also have a shape that is generally convex (from the perspective of the outside of the pet housing 100) and may align with the top portion 102 so that they may be selectively coupled together. The bottom portion 106 may also have stability members 150 to help stabilize the housing 100 from rolling over. The stability members 150 may extends outwardly from the bottom portion 106 and downwardly such that they each contact the ground when the housing 100 is placed on the ground. In some embodiments, four or more stability members 150 may be provided and distributed about the perimeter of the bottom member 150. The bottom portion 106 may also include contours that prevent the entire surface of the bottom portion from contacting the ground. The contours may more easily be seen in FIG. 10, which shows an exploded view of the housing 100 with the top, middle, and bottom portions 102, 104, and 106 separated.

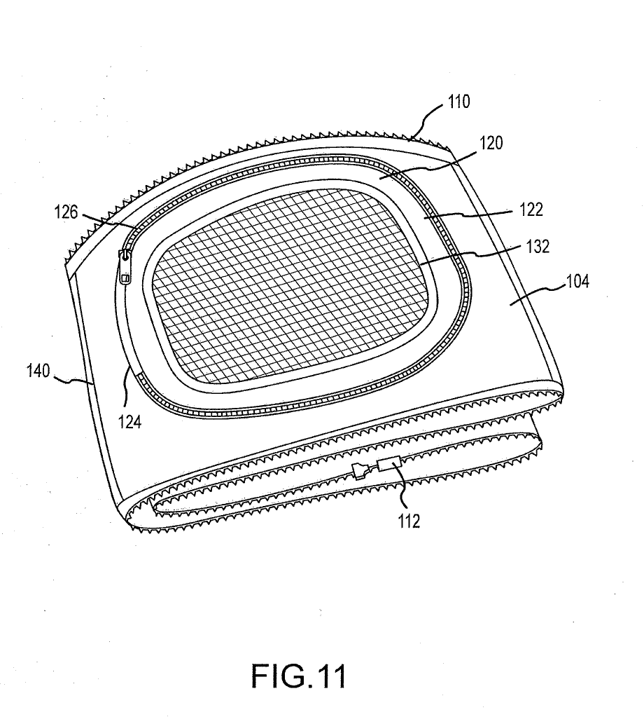

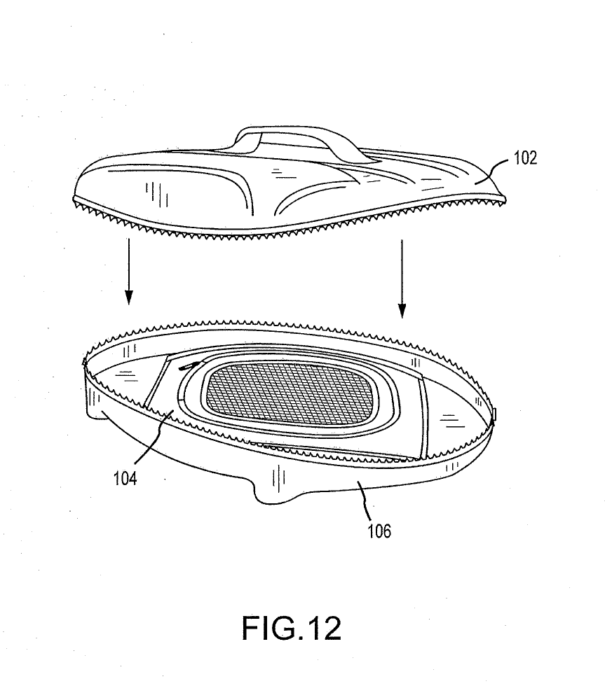

FIG. 11 illustrates the middle portion 104 in a folded position. Generally, the middle portion 104 may be made of material that allows for easy folding. In some embodiments, the middle portion 104 may be folded at or near panel joints of the middle portion 104. The middle portion 104 may be folded sufficiently to allow for it to fit within the top or bottom portions 102 and 106. FIG. 12 shows the middle portion 104 folded and fitting inside the bottom portion.

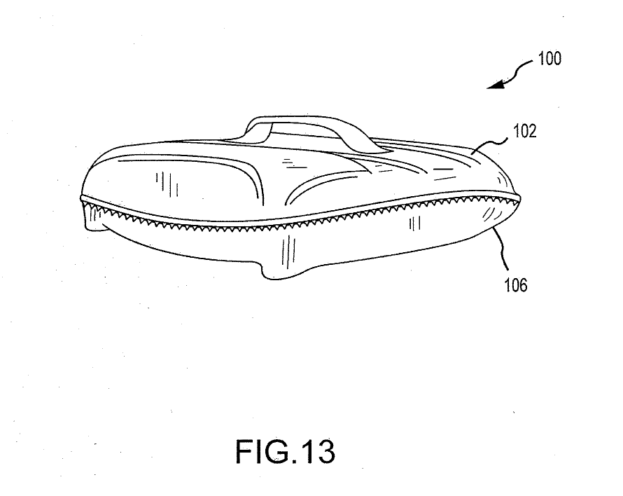

The top portion 102 may be coupled to the bottom portion 106 to form a carrying case having a cavity formed therein, with the cavity being structured to receive the middle portion 104 encapsulated therein for ease of storage, transport and/or display, as shown in FIG. 13. Specifically, the top portion 102 and bottom portion 106 may be zippered together. Hence, the top and bottom portions 102 and 106 may be selectively secured together and may hold the middle portion 104. The cavity formed between the top and bottom portions 102 and 106 may be of a size sufficient to store items in addition to the middle portion 104. For example, the cavity may store a pillow for a pet, a leash, a toy, and so on.

The pet housing apparatus 10 can be similarly zippered together, i.e., with the zipper teeth 52 and 56 being zipped together as an alternate zipper to form a carrying case from the top and bottom portions 12 and 14, and with the middle portion 16 being situated in the cavity that is positioned between the top and bottom portions 12 and 14. Moreover, the handle 28 is configured to be grasped by a user in both the carrying case configuration of the pet housing apparatus 10 as well as the pet housing configuration of the pet housing apparatus 10.

Generally, the top and bottom portions 102 and 106 may be made of a material that provides a more rigid structure than the middle portion 104. However, in some embodiments, the top and bottom portions 102 and 106 may themselves be made of different materials. For example, the bottom portion may be made of a more resilient material than the top portion. Moreover, in some embodiments, one or more panels of the middle portion 104 maybe made of a different material from other panels. The same can be said of the pet housing 10.

The foregoing describes some exemplary embodiments of pet housing having selectively separable parts for storage, transport, and/or display. Although the foregoing discussion has presented specific embodiments, persons skilled in the art will recognize that changes may be made in form and detail without departing from the spirit and scope of the embodiments to achieve similar functionality and utility to the exemplary embodiments disclosed herein. Moreover, it should be appreciated that features from a particular embodiment may be implemented in another embodiment disclosed herein to achieve a desired functionality. Accordingly, the specific embodiments described herein should be understood as examples and not limiting the scope of the disclosure.

What is claimed is:

1. A pet housing apparatus comprising:
a first portion;
a second portion;
the first and second portions being connectable together;
a third portion connectable with the first portion and the second portion;
the first, second, and third portions connected together forming a pet housing having formed therein an enclosed area structured to receive therein a pet; and
the first and second portions connected together forming a carrying case having a cavity formed therein that is structured to receive therein the second portion.

2. The pet housing apparatus of claim 1 wherein the third portion is interposed between the first and second portions when the first, second, and third portions are connected together.

3. The pet housing apparatus of claim 1 wherein:
one portion of a first cooperable fastener apparatus is disposed on the first portion and another portion of the first cooperable fastener apparatus is disposed on the third portion;
one portion of a second cooperable fastener apparatus is disposed on the third portion and another portion of the second cooperable fastener apparatus is disposed on the second portion; and
the one portion of the first cooperable fastener apparatus and the another portion of the second cooperable fastener apparatus being cooperably connected together when the first and second portions are connectable together.

4. The pet housing apparatus of claim 1 wherein:
the first portion comprises a first set of zipper teeth;
the second portion comprises a second set of zipper teeth;
the third portion comprises a third set of zipper teeth and a fourth set of zipper teeth,
the first and third sets of zipper teeth being connectable together as a first zipper, and the second and fourth sets of zipper teeth being connectable together as a second zipper when the first, second, and third portions are connected together;
the first and second sets of zipper teeth being connectable together as an alternative zipper when the first and second portions are connected together.

5. The pet housing apparatus of claim 1 wherein the first and second portions are of substantially the same shape and are nestable together.

6. The pet housing apparatus of claim 5 wherein the first and second portions nested together are structured to receive the third portion therebetween.

7. The housing apparatus of claim 5 wherein the first and second portions nested together are structured to receive the third portion in a folded condition therebetween.

8. The pet housing apparatus of claim 1 wherein one of the first portion and the second portion comprises a handle disposed generally centrally thereon and that is structured to be grasped whether the pet housing apparatus is in the form of the pet housing or is in the form of the carrying case.
